(19) United States
(12) Patent Application Publication
(10) Pub. No.: US 2008/0260022 A1
(43) Pub. Date: Oct. 23, 2008

(54) Method for making macroblock adaptive frame/field decision

(75) Inventors: Yu-Wen Huang, Taipei City (TW); To-Wei Chen, Jhongli City (TW)

Correspondence Address: THE LAW OFFICES OF ANDREW D. FORTNEY, PH.D., P.C., 401 W FALLBROOK AVE STE 204, FRESNO, CA, 93711-5835, US

(73) Assignee: Media Tek Inc.

(21) Appl. No.: 11/788,709

(22) Filed: Apr. 20, 2007

(51) Int. Cl. H04N 11/02

(52) U.S. Cl. 375/240.02; 375/E07.125; 375/E07.176; 375/E07.139; 375/E07.133

(57) ABSTRACT

A method for making macroblock adaptive frame/field (MBAFF) decision based on information of a current macroblock pair is provided. The method includes the steps of: (a) performing a spatial frame/field decision process based on spatial information of the current macroblock pair; (b) performing a temporal frame/field decision process based on temporal information of the current macroblock pair; and (c) conducting a confidence estimation to select frame coding or field coding in accordance with the information of the current macroblock pair and decisions made by the spatial and temporal frame/field decision processes before generating a bitstream corresponding to the current macroblock pair.

### BACKGROUND OF THE INVENTION

1. Field of the Invention

The invention relates to macroblock-based adaptive frame/field (MBAFF) video coding and, more particularly, to fast MBAFF decision methods for encoding SD/HD videos.

2. Description of the Prior Art

For interlaced content, the H.264 standard allows two fields to be coded either jointly, i.e. frame coding, or separately, i.e. field coding. The frame/field coding concept can be extended to the macroblock level called macroblock-based adaptive frame/field (MBAFF) coding in H.264/AVC. The concept of MBAFF coding decision was originated from MPEG2 standard. Instead of splitting up a 16×16 macroblock into two 16×8 blocks, macroblock pair is defined as a decision unit. Each macroblock pair consists of two vertically adjacent macroblocks.

MBAFF coding for interlace videos provides additional gain (e.g. 2 dB PSNR gain) over non-interlace coding, that is the required bit rate can be reduced (e.g. 35% bit rate reduction) while maintaining the original coding gain. In the H.264 reference software, the MBAFF decision is made using a “brute force” approach by encoding the macroblock pair in both frame and field modes, and choosing the one that yields a lower rate-distortion (R-D) Lagrange cost. However, the entire MBAFF coding complexity is more than doubled in comparison with non-MBAFF coding.

There are some prior arts aiming to reduce the complexity of MBAFF coding while keeping the gain achieved by implementing MBAFF coding, for example, utilizing temporal information such as motion vectors of previously encoded neighboring macroblock pairs to make frame/field decision for the current macroblock pair. Robustness cannot be guaranteed when motion field is not regular across macroblock pair boundaries, or when scene changes occur.

### SUMMARY OF THE INVENTION

A scope of the invention is to provide a method for making MBAFF decision based on information of the current macroblock pair. In some embodiments, each macroblock pair is encoded only once as frame or field, which saves approximately 50 percents of the computation.

According to an embodiment, the method comprises the steps of: (a) performing a spatial frame/field decision process based on spatial information of the current macroblock pair; (b) performing a temporal frame/field decision process based on temporal information of the current macroblock pair; and (c) conducting a confidence estimation to select frame coding or field coding in accordance with the information of the current macroblock pair and decisions made by the spatial and temporal frame/field decision processes before generating a bitstream corresponding to the current macroblock pair.

Since frame or field coding will be determined before encoding each macroblock pair, each macroblock pair is encoded once, computational complexity can be reduced comparing to conventional MBAFF coding.

The advantage and spirit of the invention may be understood by the following recitations together with the appended drawings.

### BRIEF DESCRIPTION OF THE APPENDED DRAWINGS

FIG. 1 is a flowchart showing a method for real-time macroblock-based adaptive frame/field decision according to an embodiment.

FIG. 2 is a flowchart illustrating step S10 shown in FIG. 1 in detail.

FIG. 3 is a flowchart illustrating step S12 shown in FIG. 1 in detail.

FIG. 4 is a flowchart showing how to generate the frame distortion value in step S120 shown in FIG. 3.

FIG. 5 is a flowchart showing how to generate the field distortion value in step S122 shown in FIG. 3.

FIG. 6 is a flowchart illustrating step S14 shown in FIG. 1 in detail.

FIG. 7 is a flowchart illustrating step S140 shown in FIG. 6 in detail.

### DETAILED DESCRIPTION OF THE INVENTION

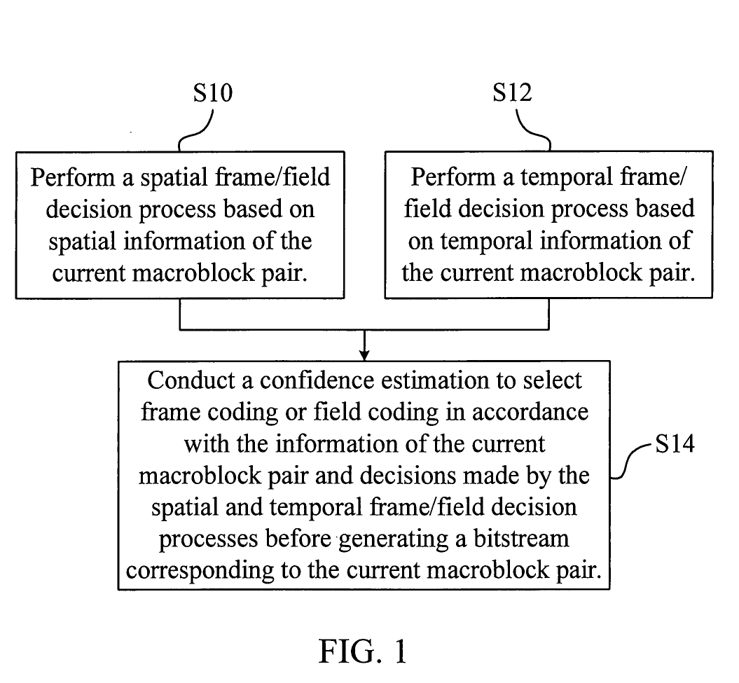

FIG. 1 is a flowchart showing a macroblock-based adaptive frame/field decision method according to an embodiment of the invention. In step S10, a spatial frame/field decision process is performed based on spatial information of the current macroblock pair. In step S12, a temporal frame/field decision process is performed based on temporal information of the current macroblock pair. In step S14, confidence estimation is conducted to select frame coding or field coding in accordance with the information of the current macroblock pair and decisions made by the spatial and temporal frame/field decision processes before generating a bitstream corresponding to the current macroblock pair.

In this embodiment, the temporal information for the temporal frame/field decision process is generated while performing integer motion estimation (IME). The bitstream corresponding to the current macroblock pair is generated by a predetermined coding process comprising IME, fractional motion estimation (FME), intra prediction (IP), and rate-distortion optimization (RDO), where RDO may include forward transform, inverse transform, quantization, inverse quantization, entropy coding, and distortion calculation.

In some other embodiments, the temporal information is generated by performing one or a combination of IME, FME, and RDO. Comparing to the case of utilizing temporal information generated while conducting IME calculation in the temporal frame/field decision process, the decision result is typically more accurate if the temporal information is generated in a later encoding stage.

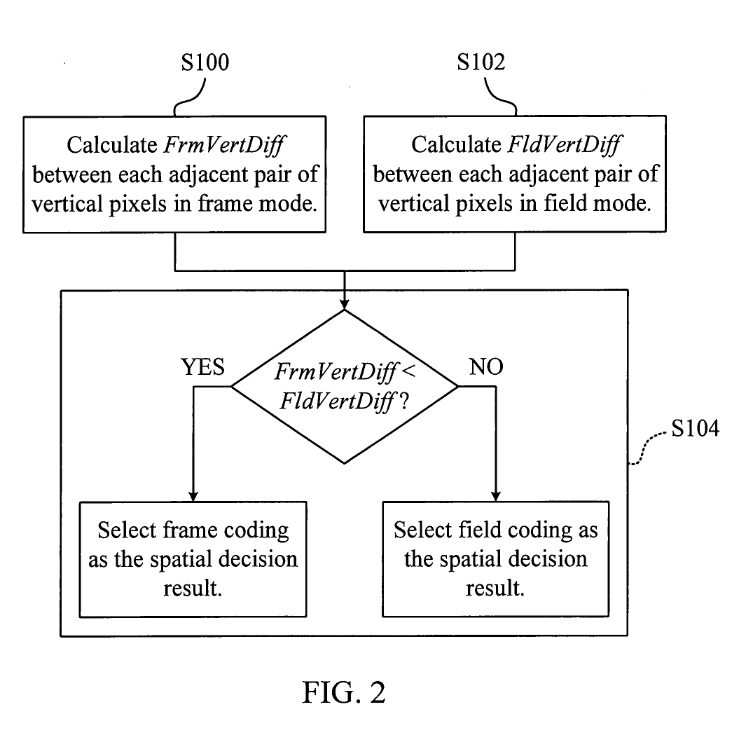

FIG. 2 is a flowchart showing step S10 shown in FIG. 1 in detail. The current macroblock pair consists of a plurality of pixels. In this embodiment, the current macroblock pair consists of 32*16 pixels for example. The spatial frame/field decision process includes calculating the sum of absolute difference between each adjacent pair of vertical pixels in top and bottom frames or in top and bottom fields.

As shown in step S100 of FIG. 2, the encoding system calculates a frame vertical difference (FrmVertDiff) between each adjacent pair of vertical pixels in frame mode, an exemplary equation for calculating FrmVertDiff is shown in the following (Equation 1), where I_{r,c} represents the luminance value at row (r) and column (c) in the current 32*16 macroblock pair.

$$\text{Equation 1:}$$

$$FrmVertDiff = {\sum }_{r = 0}^{14} ( {\sum }_{c = 0}^{15} \vert {I}_{r , c} - {I}_{r + 1 , c} \vert ) + {\sum }_{r = 16}^{30} ( {\sum }_{c = 0}^{15} \vert {I}_{r , c} - {I}_{r + 1 , c} \vert ) .$$

In step S102, the encoding system calculates a field vertical difference (FldVertDiff) between each adjacent pair of vertical pixels in field mode, an exemplary equation for calculating FldVertDiff is shown in the following (Equation 2).

$$\text{Equation 2:}$$

$$FldVertDiff = {\sum }_{r = 0}^{14} ( {\sum }_{c = 0}^{15} \vert {I}_{2 r , c} - {I}_{2 r + 2 , c} \vert ) + {\sum }_{r = 0}^{14} ( {\sum }_{c = 0}^{15} \vert {I}_{2 r + 1 , c} - {I}_{2 r + 3 , c} \vert ) .$$

In step S104, the encoding system compares the frame vertical difference (FrmVertDiff) with the field vertical difference (FldVertDiff) to determine the spatial decision result to be either frame coding or field coding. For example, if the frame vertical difference is smaller than the field vertical difference (FrmVertDiff<FldVertDiff), frame coding is selected as the spatial decision result, otherwise, field coding is selected as the spatial decision result. In some other embodiments, frame coding is the preferred coding mode, so frame coding is selected if FrmVertDiff is smaller than or equal to FldVertDiff.

In some other embodiments, the spatial decision result is determined before completely calculating either one of FrmVertDiff and FldVerDiff or both FrmVertDiff and FldVerDiff. For example, the encoding system may select frame mode solely based on FrmVertDiff (e.g. FrmVertDiff is less than a threshold), or the encoding system may compare FrmVertDiff and FldVerDiff when the calculation results of both FrmVertDiff and FldVerDiff are half completed (e.g. comparing FrmVertDiff with regard to top frame and FldVerDiff is with regard to top field.

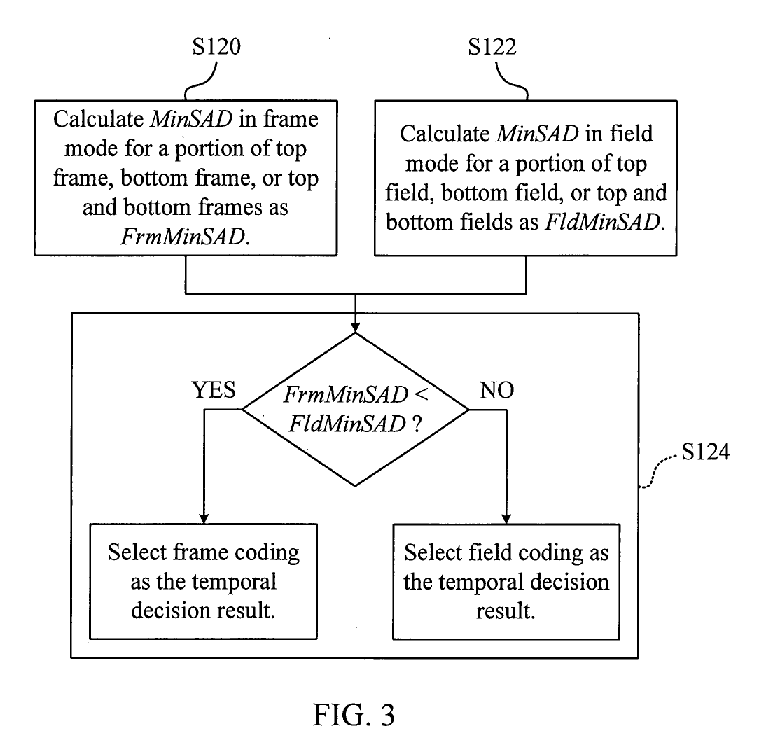

FIG. 3 is a flowchart showing step S12 shown in FIG. 1 in detail. In this embodiment, the current macroblock pair is divided into a top frame and a bottom frame in frame mode, or a top field and a bottom field in field mode.

As shown in step S120 of FIG. 3, the encoding system calculates minimum sum of absolute difference (MinSAD) in frame mode for a portion of top frame, bottom frame, or top and bottom frames as a frame distortion value (FrmMinSAD).

In step S122, the encoding system calculates MinSAD in field mode for a portion of top field, bottom field, or top and bottom fields as a field distortion value (FldMinSAD).

In an embodiment, the frame distortion value FrmMinSAD is calculated by summing MinSAD of the top frame and MinSAD of the bottom frame, similarly, the field distortion value FldMinSAD is calculated by summing MinSAD of the top field and MinSAD of the bottom field. However, there are several ways to speed up computation for the temporal frame/field decision. For example, the frame distortion value FrmMinSAD can be generated by calculating only MinSAD of the top frame, the bottom frame, a portion of top frame, a portion of bottom frame, or a portion of top and bottom frame. It is also applicable for speeding up computation of the field distortion value FldMinSAD. Another way to reduce the computational complexity is to select a fewer number of previously encoded frames as reference frame for IME.

In step S124, the frame distortion value and field distortion value is compared, and if the frame distortion value is smaller than the field distortion value (FrmMinSAD<FldMinSAD), frame coding is selected as the temporal decision result, otherwise, field coding is selected as the temporal decision result. In some other embodiments, frame coding is the preferred coding mode, so frame coding is selected if FrmMinSAD is smaller than or equal to FldMinSAD.

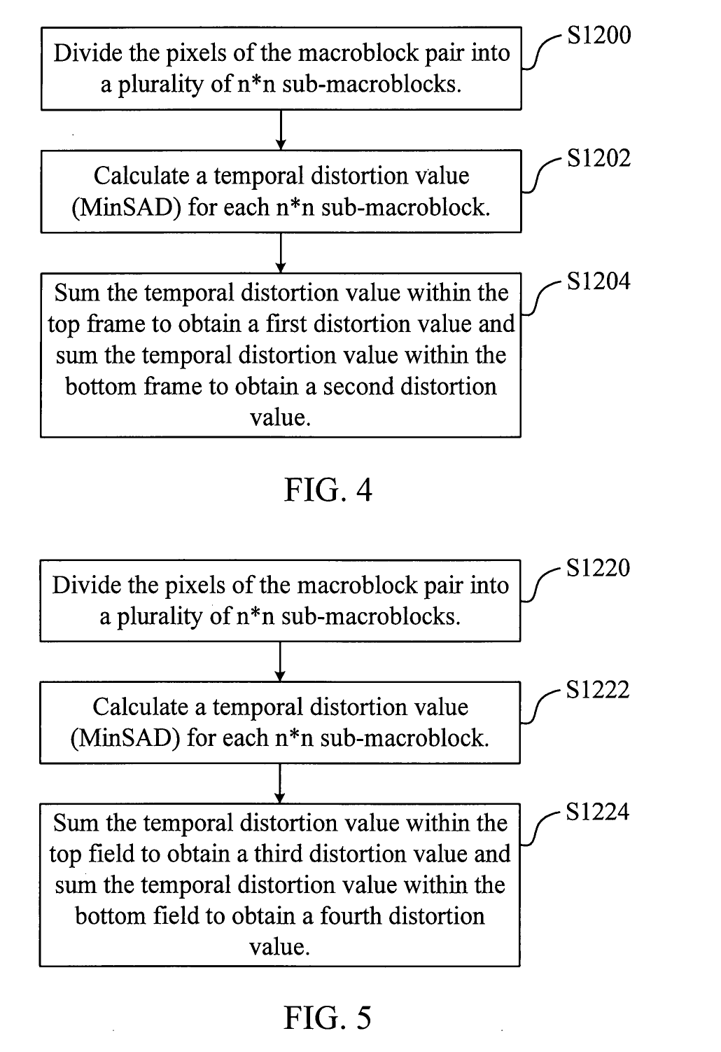

FIG. 4 is a flowchart showing an exemplary method of generating the frame distortion value (FrmMinSAD) in step S120 of FIG. 3. In step S1200, the pixels of the macroblock pair are divided into a plurality of n*n sub-macroblocks, where n is a natural number. For example, the sub-macroblock may be 4*4, 6*6, 8*8, and so on. Step S1202 is performed to calculate a temporal distortion value (MinSAD) for each n*n sub-macroblock, and step S1204 is performed to respectively sum the temporal distortion value within the top frame to obtain a first distortion value (TopFrmMinSAD) and sum the temporal distortion value within the bottom frame to obtain a second distortion value (BotFrmMinSAD). The frame distortion value (FrmMinSAD) can be computed by summing the first distortion value (TopFrmMinSAD) and the second distortion value (BotFrmMinSAD).

FIG. 5 is a flowchart showing an exemplary method of generating the field distortion value (FldMinSAD) in step S122 of FIG. 3. In step S1220, the pixels of the macroblock pair are divided into a plurality of n*n sub-macroblocks, wherein n is a natural number. For example, the sub-macroblock may be 4*4, 6*6, 8*8, and so on. Step S1222 is performed to calculate a temporal distortion value (MinSAD) for each n*n sub-macroblock. Step S1224 is performed to respectively sum the temporal distortion values within the top field to obtain a third distortion value (TopFldMinSAD) and sum the temporal distortion values within the bottom field to obtain a fourth distortion value (BotFidMinSAD). The field distortion value can be computed by summing the third distortion value and the fourth distortion value.

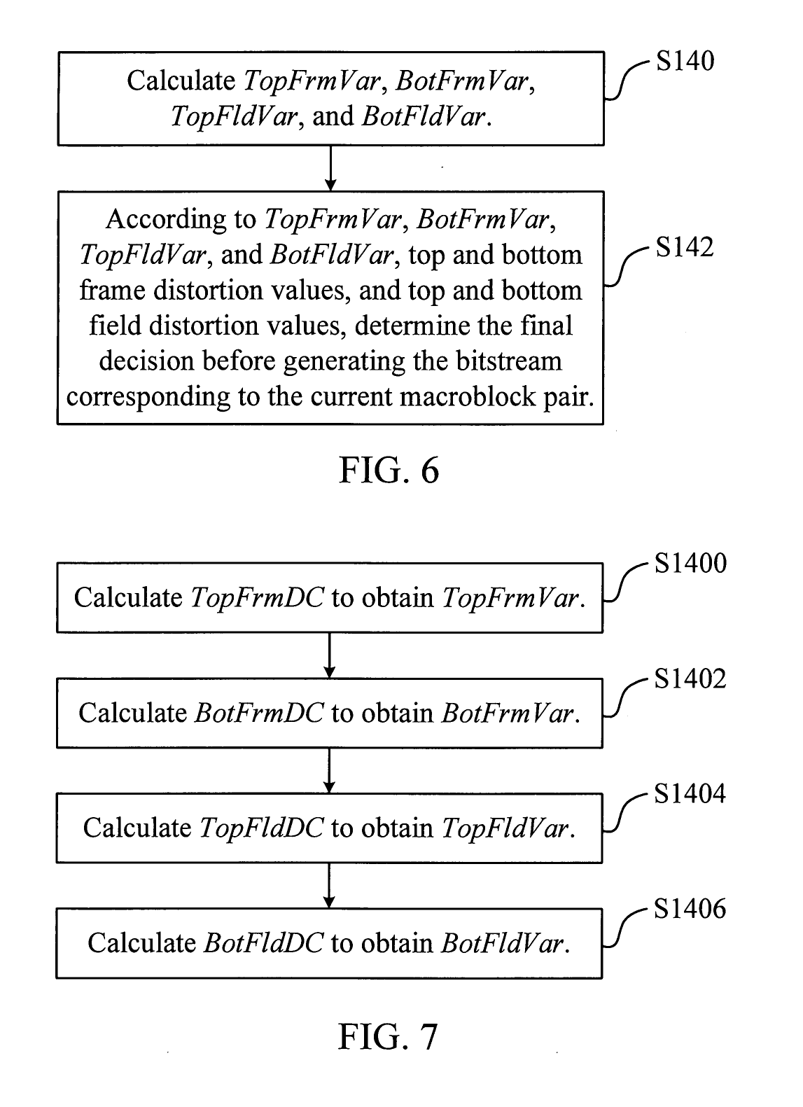

FIG. 6 is a flowchart illustrating an exemplary confidence estimation method as shown in step S14 of FIG. 1. The confidence estimation is conducted to determine the final decision for encoding the current macroblock. If motion vectors of all sub-macroblocks are zero, frame coding is selected for the current macroblock. In step S140, a top frame variance (TopFrmVar) is calculated to indicate the degree of variation in luminance value between pixels in the top frame of the current macroblock pair, a bottom frame variance (BotFrmVar) is calculated to indicate the degree of variation in luminance value between pixels in the bottom frame. Similarly, a top field variance (TopFldVar) for the top field of the current macroblock pair and a bottom field variance (BotFldVar) for the bottom field are calculated.

In step S142, according to the top frame variance, bottom frame variance, top field variance, bottom field variance, top and bottom frame distortion values, and top and bottom field distortion values, the final decision may be determined before generating the bitstream corresponding to the current macroblock pair.

FIG. 7 is a flowchart showing an embodiment of step S140 in FIG. 6 in detail. Note that the sequence shown in FIG. 7 is only an example. In step S1400, the luminance value of each pixel within the top frame is averaged by Equation 3 to obtain a top frame DC value (TopFrmDC) and the top frame variance (TopFrmVar) is calculated by summing the absolute difference between each pixel and the top frame DC value (TopFrmDC) by Equation 4.

$$\text{Equation 3:}$$

$$TopFrmDC = \frac{( {\sum }_{r = 0}^{15} {\sum }_{c = 0}^{15} {I}_{r , c} + 128 )}{256} . \\ \text{Equation 4:}$$

$$TopFrmVar = {\sum }_{r = 0}^{15} {\sum }_{c = 0}^{15} \vert {I}_{r , c} - TopFrmDC \vert .$$

In step S1402, the luminance of each pixel within the bottom frame is averaged by Equation 5 to obtain a bottom frame DC value (BotFrmDC) and Equation 6 sums the absolute difference between each pixel and the bottom frame DC value (BotFrmDC) to obtain the bottom frame variance (BotFrmVar).

$$\text{Equation 5:}$$

$$BotFrmDC = \frac{( {\sum }_{r = 0}^{15} {\sum }_{c = 0}^{15} {I}_{r + 16 , c} + 128 )}{256} . \\ \text{Equation 6:}$$

$$BotFrmVar = {\sum }_{r = 0}^{15} {\sum }_{c = 0}^{15} \vert {I}_{r + 16 , c} - BotFrmDC \vert .$$

Similarly, in step S1404, Equation 7 averages the luminance of each pixel within the top field to obtain a top field DC value (TopFldDC) and Equation 8 sums the absolute difference between each pixel and the top field DC value (TopFldDC) to obtain the top field variance (TopFldVar).

$$\text{Equation 7:}$$

$$TopFldDC = \frac{( {\sum }_{r = 0}^{15} {\sum }_{c = 0}^{15} {I}_{2 r , c} + 128 )}{256} . \\ \text{Equation 8:}$$

$$TopFldVar = {\sum }_{r = 0}^{15} {\sum }_{c = 0}^{15} \vert {I}_{2 r , c} - TopFldDC \vert .$$

In step S1406, Equation 9 averages the luminance of each pixel within the bottom field to obtain a bottom field DC value (BotFldDC) and Equation 10 sums the absolute difference between each pixel and the bottom field DC value (BotFldDC) to obtain the bottom field variance (BotFldVar).

$$\text{Equation 9:}$$

$$BotFldDC = \frac{( {\sum }_{r = 0}^{15} {\sum }_{c = 0}^{15} {I}_{2 r + 1 , c} + 128 )}{256} . \\ \text{Equation 10:}$$

$$BotFldVar = {\sum }_{r = 0}^{15} {\sum }_{c = 0}^{15} \vert {I}_{2 r + 1 , c} - BotFldDC \vert .$$

In this embodiment, if the top frame variance is smaller than the first distortion value (TopFrmVar<TopFrmMinSAD), the bottom frame variance is smaller than the second distortion value (BotFrmVar<BotFrmMinSAD), the top field variance is smaller than the third distortion value (TopFldVar<TopFldMinSAD), and the bottom field variance is smaller than the fourth distortion value (BotFldVar<BotFldMinSAD), the spatial decision result is selected as the final decision, otherwise, the temporal decision result is selected. In another embodiments, if at least one of TopFrmVar<TopFrmMinSAD, BotFrmVar<BotFrmMinSAD, TopFldVar<TopFldMinSAD, BotFldVar<BotFldMinSAD is true, the spatial decision result is selected as the final decision, else the temporal decision result is selected.

According to the aforesaid embodiment, if frame coding is selected as the final decision, the bitstream will be generated by performing frame coding for the current macroblock pair. On the other hand, if field coding is selected as the final decision, the bitstream will be generated by performing field coding for the current macroblock pair.

Furthermore, in another embodiment, if field coding is selected as the final decision, not only field coding will be performed, but also frame coding with reduced complexity will be performed, and by comparing the coding results, it is possible to change from field coding to frame coding. On the other hand, if frame coding is selected as the final decision, frame coding and field coding with reduced complexity will be performed, and then frame or field coding will be reselected for the current macroblock pair.

Compared to the prior art, the invention proposes simple and effective MBAFF decision algorithms for video coding. Since frame or field coding can be determined before actual encoding each macroblock pair, more than 50 percents of the computational complexity can be saved. The MBAFF decision algorithm can be applied to various applications, such as TV/DVD recorder, camcorder, videophone, multimedia short message, IP surveillance camera, and so.

With the example and explanations above, the features and spirits of the invention will be hopefully well described. Those skilled in the art will readily observe that numerous modifications and alterations of the device may be made while retaining the teaching of the invention. Accordingly, the above disclosure should be construed as limited only by the metes and bounds of the appended claims.

What is claimed is:

1. A method for making macroblock adaptive frame/field (MBAFF) decision based on information of a current macroblock pair, the method comprising the steps of:
(a) performing a spatial frame/field decision process based on spatial information of the current macroblock pair;
(b) performing a temporal frame/field decision process based on temporal information of the current macroblock pair; and
(c) conducting a confidence estimation to select frame coding or field coding in accordance with the information of the current macroblock pair and decisions made by the spatial and temporal frame/field decision processes before generating a bitstream corresponding to the current macroblock pair.

2. The method of claim 1, wherein the temporal information for the temporal frame/field decision process is generated while performing integer motion estimation (IME).

3. The method of claim 1, wherein the temporal information is generated by performing one or a combination of processes selected from a group consisting of IME, fractional motion estimation (FME), and rate-distortion optimization (RDO).

4. The method of claim 1, wherein the bitstream corresponding to the current macroblock pair is generated by a predetermined coding process comprising IME, FME, intra prediction (IP), and RDO.

5. The method of claim 4, wherein RDO comprises one or a combination of tasks including forward transform, inverse transform, quantization, inverse quantization, entropy coding, and distortion calculation.

6. The method of claim 1, wherein the current macroblock pair consists of a plurality of pixels, and the spatial frame/field decision process comprises the steps of:
(a1) calculating a frame vertical difference between each adjacent pair of vertical pixels in frame mode;
(a2) calculating a field vertical difference between each adjacent pair of vertical pixels in field mode; and
(a3) comparing the frame vertical difference with the field vertical difference, if the frame vertical difference is smaller than the field vertical difference, selecting frame coding as the spatial decision result, otherwise, selecting field coding as the spatial decision result.

7. The method of claim 1, wherein the temporal frame/field decision process comprises the steps of:
(b1) based on the information of the current macroblock pair, generating a frame distortion value and a field distortion value; and
(b2) based on the frame distortion value and the field distortion value, selecting frame or field coding as the temporal decision result.

8. The method of claim 7, wherein the current macroblock pair is divided into a top frame and a bottom frame in frame mode, or a top field and a bottom field in field mode, and the step (b2) comprises the step of:
comparing the frame distortion value and field distortion value, if the frame distortion value is smaller than the field distortion value, selecting frame coding as the temporal decision result, otherwise, selecting field coding as the temporal decision result.

9. The method of claim 8, wherein the step (b1) comprises the steps of:
(b11) calculating a portion of the top frame, bottom frame, or top and bottom frames as the frame distortion value; and
(b12) calculating a portion of the top field, bottom field, or top and bottom fields as the field distortion value.

10. The method of claim 9, wherein the current macroblock pair consists of a plurality of pixels, the step (b11) comprises the steps of:
(b111) dividing the pixels into a plurality of n*n sub-macroblocks, n being a natural number;
(b112) calculating a temporal distortion value for each n*n sub-macroblock; and
(b113) respectively summing the temporal distortion value within the top frame to obtain a first distortion value and summing the temporal distortion value within the bottom frame to obtain a second distortion value, wherein the frame distortion value comprises the first distortion value and/or the second distortion value.

11. The method of claim 9, wherein the current macroblock pair consists of a plurality of pixels, the step (b12) comprises the steps of:
(b121) dividing the pixels into a plurality of n*n sub-macroblocks, n being a natural number;
(b122) calculating a temporal distortion value for each n*n sub-macroblock; and
(b123) respectively summing the temporal distortion values within the top field to obtain a third distortion value and summing the temporal distortion values within the bottom field to obtain a fourth distortion value, wherein the field distortion value comprises the third distortion value and/or the fourth distortion value.

12. The method of claim 1, wherein the current macroblock pair is divided into a top frame and a bottom frame in frame mode, or a top field and a bottom field in field mode, and conducting the confidence estimation comprises the steps of:
(c1) respectively calculating a top frame variance based on the top frame, calculating a bottom frame variance based on the bottom frame, calculating a top field variance based on the top field, and calculating a bottom field variance based on the bottom field; and
(c2) according to the top frame variance, the bottom frame variance, the top field variance, and the bottom field variance, selecting the spatial decision result or temporal decision result before generating the bitstream corresponding to the current macroblock pair.

13. The method of claim 1, wherein the step (c) further comprises the step of:
selecting frame coding if a motion vector of each sub-macroblock is equal to 0.

14. The method of claim 12, wherein the pixels are divided into a plurality of n*n sub-macroblocks, n is a natural number, the step (c1) comprises the steps of:
(c11) averaging the luminance of each pixel within the top frame to obtain a top frame DC value and summing the absolute difference between each pixel and the top frame DC value to obtain the top frame variance;
(c12) averaging the luminance of each pixel within the bottom frame to obtain a bottom frame DC value and summing the absolute difference between each pixel and the bottom frame DC value to obtain the bottom frame variance;
(c13) averaging the luminance of each pixel within the top field to obtain a top field DC value and summing the absolute difference between each pixel and the top field DC value to obtain the top field variance; and
(c14) averaging the luminance of each pixel within the bottom field to obtain a bottom field DC value and summing the absolute difference between each pixel and the bottom field DC value to obtain the bottom field variance.

15. The method of claim 12, wherein the step (c2) comprises the step of:
selecting the spatial decision result if all of the following conditions are satisfied: the top frame variance is smaller than a first distortion value, the bottom frame variance is smaller than a second distortion value, the top field variance is smaller than a third distortion value, and the bottom field variance is smaller than a fourth distortion value, otherwise, selecting the temporal decision result;
wherein the first, second, third, and fourth distortion values are calculated by summing temporal distortion values of n*n sub-macroblock within the top frame, bottom frame, top field, and bottom field respectively.

16. The method of claim 12, wherein the step (c2) comprises the step of:
selecting the spatial decision result if at least one of the following conditions is satisfied: the top frame variance is smaller than a first distortion value, the bottom frame variance is smaller than a second distortion value, the top field variance is smaller than a third distortion value, and the bottom field variance is smaller than a fourth distortion value, otherwise, selecting the temporal decision result;
wherein the first, second, third, and fourth distortion values are calculated by summing temporal distortion values of n*n sub-macroblock within the top frame, bottom frame, top field, and bottom field respectively.

17. The method of claim 1, further comprising generating the bitstream by performing frame coding for the current macroblock pair if frame coding is selected in step (c), or performing field coding for the current macroblock pair if field coding is selected in step (c).

18. The method of claim 1, further comprising the steps of:
performing field coding and frame coding with reduced complexity if field coding is selected in step (c), or performing frame coding and field coding with reduced complexity if frame coding is selected in step (c); and
selecting frame or field coding for the current macroblock pair.
